(19) United States
(12) Patent Application Publication
(10) Pub. No.: US 2006/0153616 A1
(43) Pub. Date: Jul. 13, 2006

(54) System and method for the automatic generation of printable files from data

(75) Inventor: Juergen Hofmann, Koeln (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Deutsche Post AG, Bonn (DE)

(21) Appl. No.: 10/535,506

(22) PCT Filed: Nov. 14, 2003
(86) PCT No.: PCT/DE03/03789

§ 371 Date: May 18, 2005

(30) Foreign Application Priority Data
Nov. 19, 2002 (DE) 102 54 055.1

(51) Int. Cl. B41J 5/30

(52) U.S. Cl. 400/62

(57) ABSTRACT

The invention relates to a system for the automatic generation of printable files from data in a database. The system includes a printing system having at least one print processing component, the print processing component having means for the printing and/or the further processing of the files. The printing system includes a print job generation element, which is connected to a server via an interface, the server being connected to the database via an additional interface. The invention also relates to a method for the automatic generation of printable files from the data in a database, according to which the files are generated, printed and/or further processed by a printing system having at least one print processing component and a print job generation element.

The invention relates to a system for the automatic generation of printable files from data in a database, said system comprising a printing system consisting of at least one print processing component, whereby the print processing component has means for printing and/or further processing the files.

The invention also relates to a method for the automatic generation of printable files from data in a database, according to which method the files are generated, printed out and/or further processed by a printing system consisting of at least one print processing component and one print job generation element.

The generation of printable files is acquiring increasing significance since ever-greater volumes of print objects are being generated electronically, further processed and printed out in a wide array of application areas. In particular, there is a need to generate individualized mailpieces by electronic means and to subsequently print out and further process them.

For example, postal service providers offer numerous services in the letter and mailing realm that go well beyond the mere sending of letters and parcels. Such a system supports the entire production process for documents that are printed and that are to be sent out. With the growing significance of electronic mail, this also holds true in the realm of e-mail communication and Internet-based logistics.

In this context, components of a system designed for such procedures serve various purposes. On the one hand, they serve as a receiving interface and production system for letter mailings that are ultimately printed on paper and that are delivered to the recipients by mail. On the other hand, system components with interfaces offer a direct transfer capability for messages via electronic means. Thus, the sending and delivery can be carried out through e-mail and web protocols.

A number of production-related obstacles have to be overcome in order for users to make use of these options. This ranges from the design of a mailing and the acquisition of target group addresses to the actual serial printing, including quality control. Even when specialized service providers such as letter shops and printing centers are used, the creation of mailings still proves to be quite a complex process. Multiple media discontinuities and heterogeneous interfaces or approaches among all kinds of intermediates involved make the process expensive and complicated for small mail volumes. For large-scale mailings, it is time-consuming and technically complicated.

In order to print and further process print jobs within a printing system, various print processing components such as printers, sorting and enveloping machines or other processing devices are typically used. This leads to multi-faceted possibilities in terms of hardware combinations and job sequences, each requiring a special print preparation.

Print preparation methods for all kinds of requirements are known from the state of the art. DE 199 21 120 C2, for example, describes a method and a system for the signature-wise imposition of printing data within a POD (Print On Demand) system. This involves the printing and folding of printed sheets, a process in which the printed images of consecutive pages are positioned so as to match precisely.

Furthermore, DE 100 17 785 C2 describes a method and a system for processing a data stream in which the data stream is prepared to be output by a printing device. Here, a print data stream that is present in a first print data format is converted into a standardized data format and the print data stream thus converted is indexed on the basis of prescribed indexing criteria. The indexed print data stream is then sorted in a sorting sequence according to sorting parameters and the sorted print data stream is output for purposes of further processing, especially for being printed out.

In actual practice, the problem often arises that print jobs are transmitted to different printing systems, whereby each printing system requires a different print preparation. This is particularly the case when, for example, a postal service provider receives data for print jobs from users of a service system designed for this purpose, stores this data in a central database and transmits the command for the execution of the print jobs to its own system components or to printing service providers. Typically, each printing service provider has its own specific printing system with different software and hardware components. In order for the user jobs to be prepared uniformly and to be transmitted to the particular printing system of the service provider once the data has been received by the postal service provider, the postal service provider has to know all of the specifications of the commissioned printing service provider. This, in turn, calls for extensive hardware and software on the part of the postal service provider.

DE 198 17 878 A1, for example, discloses a method and a device for producing, wrapping and enveloping printed mailings. Here, the party ordering a print job produces the print data and transmits it via a network to a printing means, where the transmitted print data is printed out. The ordering party produces the print job on his personal computer, which is connected to one or more central computers. The central computers are connected to servers that can be located, for example, in different cities or countries. The ordering party selects a server with free printing capacity and transmits the print job to this server. This print job is executed fully automatically on the selected server, whereby the server preferably has another personal computer and a printing means. The print job is stored on the personal computer and it controls the printing means and its various components such as paper rolls and gluing machines as well as printing, cutting, wrapping and folding units.

Moreover, DE 101 23 488 A1 describes a printing system for printing a plurality of jobs in one system having a plurality of processing stations. Each of the processing stations is used to render the documents into a ready-to-print file format and to issue an electronic job ticket containing global document properties. In this case, a customer transmits an order for objects to be printed either directly in paper form, on a data carrier or else via the Internet.

DE 101 22 880 A1 discloses a method for the automatic generation of printing instructions. For this purpose, a user enters instructions at a computer in response to which the computer places a plurality of received documents into an electronic folder and arranges the documents in the folder in the desired order for the printed final product. Here, a customer's job for objects to be printed is likewise transmitted to the printing system either directly in paper form, on a data carrier or else via the Internet.

The invention is based on the objective of creating a system that allows a printing system to receive data from a database outside of the area of the printing system and to automatically generate printable files on the basis of this data as a function of the specific requirements of the printing system.

It is likewise an objective of the invention to provide a method for the automatic generation of print jobs from data in a database by a printing system in which the database is located outside of the area of the printing system.

According to the invention, this objective is achieved by a system for the automatic generation of printable files from data in a database, said system comprising a printing system including at least one print processing component, whereby the print processing component has means for printing and/or further processing the files, said system comprising the following features:
the printing system has at least one print job generation element,
the print job generation element can be connected to a server via a first interface,
the server can be connected to a database via a second interface,
the print job generation element has means for requesting and receiving data from the database, and
the print job generation element has means for preparing the data from the database as a function of the requirements of the print processing component and it also has means for generating printable files.

The objective is also achieved by a method for the automatic generation of printable files from data in a database, by means of which the files are generated, printed out and/or further processed by a printing system consisting of at least one print processing component and one print job generation element, and the method includes the following steps:
the print job generation element generates a first message that contains a call to a server for a specific method with parameters,
the print job generation element establishes a connection to the server via a first interface,
the print job generation element transmits the first message to the server via the first interface,
the server processes the first message-in that it calls the specific method with the appertaining parameters,
the server establishes a connection to the database via a second interface,
the server retrieves data from the database via the second interface,
the server sends the result of the call for the specific method in the form of a second message back to the print job generation element and
the print job generation element generates at least one printable file from the result of the call for the specific method.

The printing system is, for example, a system at a service provider comprising printers, sorting and enveloping machines and/or other processing devices. According to the invention, a print job generation element that can be connected to a server is installed in such a printing system. The server, in turn, can be connected to a database containing data for print jobs to be generated. The database is located outside of the printing system and typically comprises large volumes of data. This data comes, for example, from users of a service system of a postal service provider who have placed orders for print jobs for mailings.

The print job generation element according to the invention is typically a program that is preferably installed on computers of the printing system. The term “computer” here is not to be understood in any limiting manner. This can be any unit that is suitable for executing computations such as, for example, a work station, a personal computer, a microcomputer or circuitry that is suitable for executing computations and/or comparisons.

In an especially preferred embodiment of the invention, the print job generation element in the form of a first interface can be connected to a SOAP server via a SOAP interface. The abbreviation SOAP stands for Simple Object Access Protocol. SOAP is a communication protocol for access to individual program modules on the Internet. SOAP is a lightweight protocol with which proprietary modules can be packaged and provided with generally understandable interfaces. SOAP specifies how a function procedure call takes place with XML data via computer platforms (Remote Procedure Call). Advantageously, a connection to the server is possible via the Internet, but other connections are also possible. These can be temporary or permanent connections.

According to the invention, the server can be connected to at least one database via a second interface. In an especially preferred embodiment of the invention, a PL/SQL layer is used for the connection between the server and the database. The abbreviation PL/SQL stands for Procedural Language/Structured Query Language. This is a proprietary programming language, for example, for Oracle, that adds procedural constructs and control possibilities to the non-procedural SQL. Via the server, data from the database is transmitted to the print job generation element, said data containing, for example, templates, variable data, personalization instructions and other information about the print jobs that are to be produced.

The print job generation element produces print jobs from the received data and automatically generates printable files. In this process, the print job generation element describes how the files are to be prepared for a certain paper/hardware combination. This includes, for example, information pages for the personnel, control characters for an enveloping machine, crop marks, paper formats, the production of RIP tickets for printers, SDL control characters, conversion instructions and instructions on how the data is transported to a printer.

The data in a database constitutes jobs from users pertaining to the printing of mail-pieces. Jobs from users are referred to below as UserJobs, whereas the resultant print jobs are designated as PrintJobs. Since the UserJobs produced by users can be of greatly varying sizes, and since advantageously, the Print Jobs should be neither too large nor too small for purposes of optimal production, it has proven to be practical to divide large jobs and/or to combine several small jobs into larger ones. For this purpose, special preference is given to the implementation of a mechanism that automatically divides large jobs.

Additional advantages, special features and practical refinements of the invention can be gleaned from the subordinate claims and from the presentation below of preferred embodiments making reference to the figures.

The figures show the following:

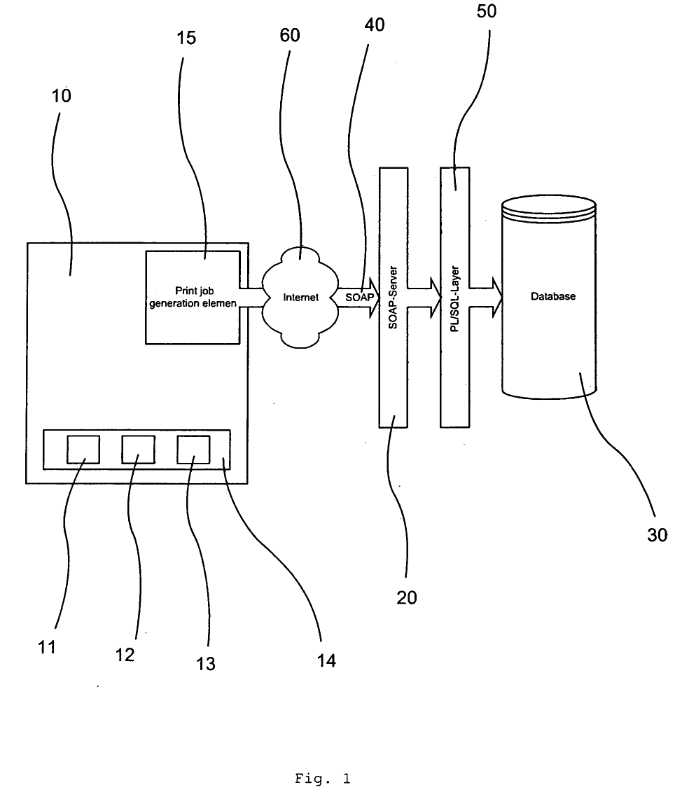

FIG. 1 the schematic structure of a system for the automatic generation of printable files;

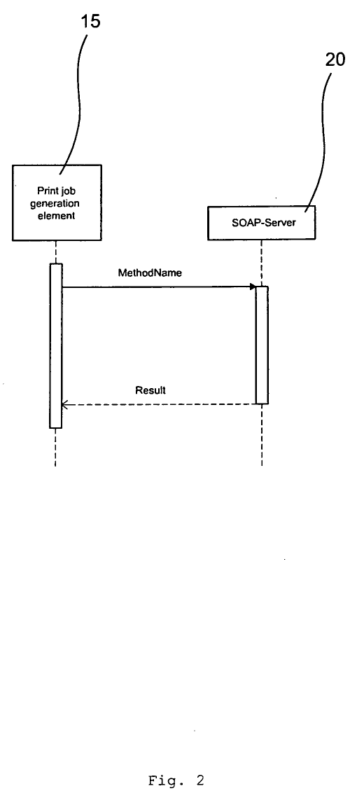

FIG. 2 a representation of the method of a call to a SOAP server;

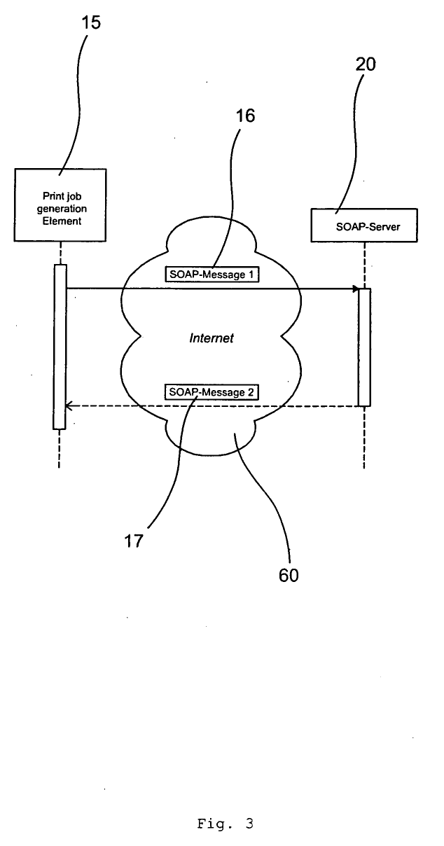

FIG. 3 a representation of the method of a call to a SOAP server via SOAP;

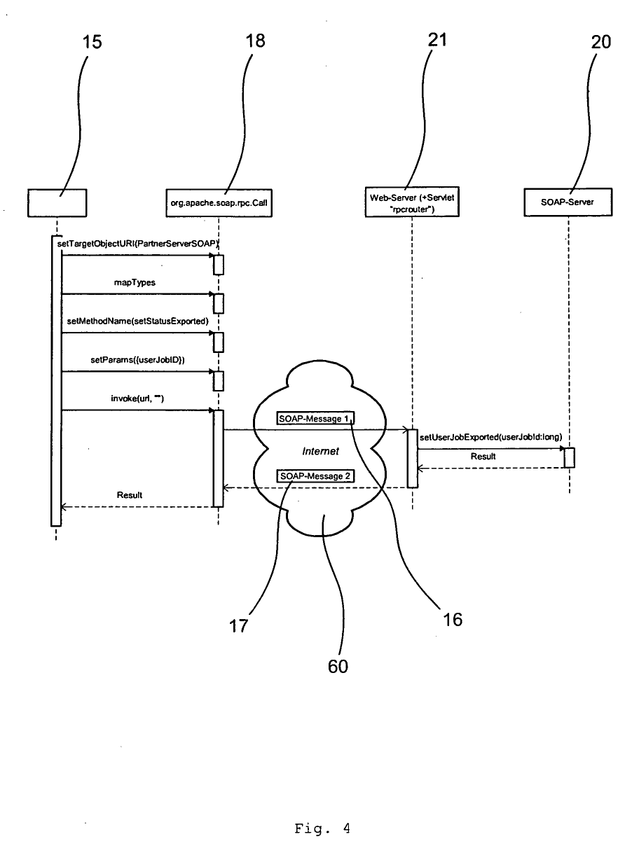

FIG. 4 a detailed representation of a call to a SOAP server via an Apache SOAP API;

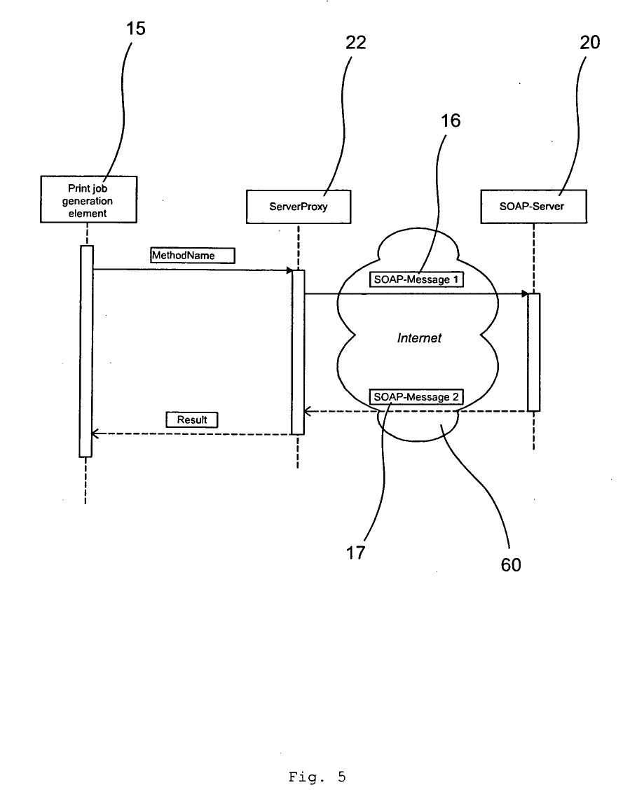

FIG. 5 the representation of a server proxy class.

FIG. 1 schematically shows the structure of the system for the automatic generation of printable files with reference to an especially preferred embodiment. According to the invention, a printing system 10 has a print job generation element 15. The printing system is located, for example, at a printing service provider that is part of a mailing system, whereby this mailing system accepts, prepares and further processes electronic data from users into letters, postcards and/or e-mails. The data from users and appertaining jobs is advantageously stored in a database 30 that is located outside of the area of the printing system.

Printing service providers typically have different printing systems with specific requirements for different print processing components 14, whereby the print processing components can comprise, for example, printers 11, sorting machines 12 and/or and enveloping machines 13. Consequently, according to the invention, a print job generation element 15 is used for the specific preparation of data in the area of the printing system 10. The print job generation element 15 is typically a program that is preferably installed on one or more computers of the printing system 10.

In order to allow the print job generation element 15 and thus the printing system 10 to access the contents of a database 30 outside of the area of the printing system, and in order to automate these steps, in an especially preferred embodiment of the invention, a client-server architecture was selected that uses SOAP as the communication medium via the Internet. For this purpose, the print job generation element 15 is connected via a first SOAP interface 40 to a SOAP server 20 outside of the area of the printing system. This first interface is preferably realized via the Internet 60. However, other types of connections can also be selected and these can be temporary or permanent connections.

A SOAP interface has the advantage over proprietary communication protocols such as CORBA (common object request broker architecture) or RMI (remote method invocation) that, for example, during the data transmission, no conflicts occur with a firewall of the print job generation element 15 and/or of the printing system 10. SOAP preferably uses HTTP/HTTPS as the data transmission protocol. HTTP/HTTPS is either permitted through most firewalls or else it is tunneled via proxies, so that it is not necessary to adapt the firewalls and no new points of attack are created. Moreover, by using a SOAP protocol that uses the HTTP protocol as the basic transport protocol, a simple transmission via the Internet is possible.

All of the methods that the print job generation element 15 needs in order to receive all of the necessary information from the database 30 for a print job are provided via the SOAP interface 40. Advantageously, the system is secured against outside access. The system can be secured in different ways. For example, an authentication of the print job generation element 15 at the server 20 can be employed. Moreover, it is advantageous to use HTTPS (HTTP Secure) as the transmission protocol.

In an especially preferred embodiment of the invention, access of the SOAP server 20 to the database 30 is carried out via a PL/SQL layer 40. In this manner, it is possible, among other things, to protocol all database accesses or to set certain attributes. This has the advantage that consistency of the database can be ensured.

It has proven to be advantageous to execute all status changes in the print job generation element without establishing a connection to the Internet and to then send the executed changes to the server. This has the advantage that the print job generation element only has to have a temporary connection to the Internet, and can operate even without a permanent Internet connection.-An Internet connection only needs to be established for the merging operations with the server.

Furthermore, an advantage of the system according to the invention is that updates for the configuration of the print job generation element can be stored centrally on the server. In an especially preferred embodiment of the invention, the print job generation element checks at the start whether any updates are available and it updates its configuration automatically from the central server via JavaWebStart.

It is also especially advantageous to execute the actual communication via SOAP through an Apache SOAP API. The abbreviation API stands for Application Programming Interface, and it is an interface specified by an operating system or an application program by means of which standardized software tools are made available to other applications. Hence, an API allows an application program to use a function and/or services of another software. In contrast to a file interface, an API is a so-called call interface. The advantages of using an API lie, for example, in the reduction of programming work and in a uniform user interface and mode of operation.

FIG. 2 shows an embodiment of a method sequence in which the print job generation element 15 calls a method on the server 20 and, after successfully executing the method, receives a result as the return value.

Method calls via SOAP appear as XML messages that are sent via HTTP. FIG. 3 shows the schematic sequence of such a call. The print job generation element 15 generates a first SOAP message 16 indicating which method with which parameters is to be called. This SOAP message is then transmitted via the Internet 60 to the SOAP server 20 by means of the HTTP protocol. This server 20 evaluates the information and data and then sends back a result as the second SOAP message 17.

In detail, the SOAP call appears using the Apache SOAP API as shown by way of example in FIG. 4. The print job generation element generates an instance of the call class of the Apache SOAP API and at first sets certain properties for this object. FIG. 3 shows various methods by way of example that are called by the print job generation element 15.

A TargetObject-URI method corresponds, for example, to an unambiguous URI that is associated on the server side in the RPC router with a certain object (in the case of the example here, with the SOAP server).

A mapTypes method is preferably called several times so as to be able to transmit its own classes (for example, UserJob, User) via the SOAP.

The method name can be specified via a setMethodName method, and a list of parameter values can be set via setParams.

An invoke method carries out the actual call via SOAP. A first message 16 is generated and this is then sent to the server 20 via HTTP.

It has proven to be advantageous that, on the part of the server 20, first of all, a web server 21 accepts the query and evaluates it. The web server can be, for example, Tomcat. In order to allow a successful SOAP call, a sent URL has to be associated with the Apache SOAP API's RPC router-servlet where the server-SOAP object is known. The call is transmitted to this servlet. The abbreviation URL stands for Uniform Resource Locator. Via a URL, all documents in the Internet can be unambiguously addressed.

The RPC router-servlet then analyzes the SOAP message, determines the class to be called and instantiates it. Then the desired method with the transmitted parameters is called. The possible return value is then, in turn, converted into a second SOAP message 17 and this is returned as a response via HTTP. The call object 18 on the client side analyzes this message and returns the obtained result to the print job generation element 15. In case of an error, a failure object can optionally be queried here.

If a print job generation element 15 calls a method on the SOAP server, then, in an especially preferred embodiment of the invention, it can use a ServerProxy class. A proxy server accepts requests from a client and returns them—optionally modified—to the original destination.

Such a sequence is shown in FIG. 5. The ServerProxy 22 encapsulates the Apache SOAP API, and offers all of the methods of the server to the print job generation element. A call for such a method is then forwarded via the Apache API and the return value is once again returned.

The SOAP response message is analyzed and
in case of an error, an exception is launched or
in case of success, the result is returned.

The appropriate methods then convert primitive data types, which are returned as objects, into the appertaining primitive data type and then return said date types. Thus, for the particular print job generation element, the SOAP communication is not transparent but rather the ServerProxy 22 behaves as if it were calling local methods (except for the longer runtimes of the methods).

In an especially preferred embodiment of the invention, the RPC (Remote Procedure Call) is selected for the communication. RPC provides a remote procedure call. Within the scope of this concept, each server in a network makes a number of services available that can be called with RPC. These functions are implemented as procedures of a program and can be addressed by indicating the server address, program number and procedure number. RPC offers the possibility of transmitting method calls and their parameters in a simple manner. This does not specify the transmission of entire XML trees as a parameter or return value. In the case of the SOAP server, preferably an expansion of the SOAP API of Apache is used, which specifies how XML trees can be transmitted via the SOAP RPC. Thus, UserJobs can be transmitted as method parameters via the Apache SOAP API.

The SOAP RPC protocol also offers the possibility to transmit simple data types such as strings or integers. However, complex data types can also be transmitted in structs or arrays which, in turn, consist of simple data types.

Various complex data types (for example, LogicalProduct, User, UserJob) are typically transmitted during the communication between the print job generation element 15 and the server 20. In order to be able to transmit these data types in the SOAP RPC protocol, methods are advantageously implemented that convert the classes as SOAP structs and vice versa (serialization/deserialization). However, this step is simplified by the Apache SOAP API in that it provides a class that offers this functionality for all classes that comply with a JavaBeans specification. This is why the three data classes are advantageously implemented on the basis of the JavaBeans specification and can thus be transmitted via the SOAP API in a simple manner. JavaBeans are a portable platform-independent component model that is written in Java.

Below, an especially preferred embodiment of a print job generation element that is installed in a printing system is presented by way of an example. Especially advantageously, the realization of the print job generation element is in the form of an XML configuration. Such a configuration can control the entire production sequence for the printing. The operation advantageously takes place via a graphic user interface by means of which, for example, actions can be initiated and parameters can be entered. The printable files can be transmitted automatically to a production printer.

By means of the print job generation element, a printing system can transfer orders assigned to it, for example, from a mailing system to its own local systems and it can report back to the mailing system about the processing status. As a local application, the print job generation element assumes the central function of preparing the print data. The preparation of the print data can comprise, for example, the following functions:
preparation of job data in XML format to create throughput-optimized printing machine jobs and finishing-specific print jobs.
combining individual print jobs.
converting print jobs into other formats if a printing machine needs this format.
Providing print jobs with machine-specific control characters needed for automatic processing. These can be, for instance, barcodes.
Generating reprints in order to allow post-processing of individual mailings in case of production errors.

The configuration of the print job generation element advantageously consists of modules, virtual printers and settings.

General settings such as, for example, paths and communication parameters, are configured in the settings. The parameters can be changed by means of a user interface of the print job generation element. The following table lists the meaning/function of a few possible setting parameters by way of example:

| Parameter | Function |
|---|---|
| http.proxy | “true” or “false” determines whether the Internet connection is made |
| | via a proxy. |
| http.proxy.host | Proxy host name |
| http.proxy.port | Port to be used for the communication with the proxy |
| http.proxy.loginbox | “true” or “false” determines whether the user interface |
| | displays a loginbox at the time of the login at the partner |
| | server in which user name and password for the proxy |
| | can be indicated. |
| http.proxy.user | User name for proxy login |
| http.proxy.passwd | Password for proxy login |
| soap.protocol | The protocol to be used for the SOAP communication. |
| | For example, “http” and “https” are supported |
| soap.host | Host name of the SOAP partner server |
| soap.port | The port to be used for the SOAP communication. |
| soap.path | The path on the SOAP partner server |
| soap.serviceid | The service ID on the SOAP partner server |
| http.auth | “true” or “false”, determines whether |
| http.auth.user | User name for HTTP authentication |
| http.auth.passwd | Password name for HTTP authentication |
| site | Name of the production site |
| instanceid | Instance ID of the instance used. Serves for the use of |
| | several computers at one site |
| basepath | Base path |
| outputpath | Output path for the generated files |
| temppath | Path in which temporary files are stored |
| queuemanagerpath | Path in which a queue manager stores its files |
| errorpath | Path in which the error log files are stored |
| partnerid | Partner ID of the printing service provider |
| partnername | Name of the printing service provider |
| partnerstreet | Street of the printing service provider |
| partnerpc | Postal code of the printing service provider |
| partnertown | City of the printing service provider |
| warningdays | Number of days after a UserJob whose status has not |
| | changed is to become, for example, yellow in the user interface |
| compatibility | Must equal “false” |
| archivesample | Number of addresses above which specimen copies are to be produced |
| | for a UserJob |
| pdflibserial | Serial number for the PDF lib |

In order to generate printable files from a PrintJob XML file, it has proven to be advantageous to provide a PDF kernel. The way in which the printable files are produced is described by a configuration language. The kernel is informed by the interface of only one PrintJob XML file and one virtual printer to be used.

In order to generate print data, the print job component receives job data consisting, for example, of a template in PDF format and variable data for the personalization and meta-information in XML format. Making use of an external PDF library, which can be located, for instance, in the database 30, the print job generation element finally generates completed PDF files. The generation technique depends on the job data and on the hardware-independent meta-information such as, for example, the size of the print job, sorting according to postal criteria, routing slip instructions for the postal delivery and/or attachments. It is also carried out as a function of hardware-specific meta-information such as imposition, performance optimization and/or specific barcodes that are configured in the virtual printers.

The generation technique also depends on how the processing is defined. Therefore, the print job generation element is also an interpreter that derives its logic from a processing file, preferably in XML format. For instance, if a print job generation element is supposed to be able to generate folding greeting cards with text on one side rather than generating postcards, then merely the processing file has to be adapted. This is carried out at a central place in the mailing system and, at the time of the next start-up, the change is automatically transmitted to the print job generation element so that the print job generation element can now generate greeting cards with text on one side.

The possibilities for producing a document are very multi-faceted and depend on several factors such as the original format, desired colors, paper format to be printed, final processing and printers employed. In order to describe how a document is to be produced for a concrete case, the term “virtual printer” has been introduced. A virtual printer describes the prerequisites under which a document can be produced with said printer and how the document will be prepared for this concrete case.

It is possible that different documents can be produced with the same virtual printer, for example, color as well as black-and-white documents could be generated with a color printer following the same preparation. It is possible for different virtual printers to use the same physical printer for the printing, for example, documents having the original format of DIN A4 can be printed on DIN A4 as well as on DIN A3 with a subsequent post-production. The two cases call for different preparation of the files and thus have to be prepared with different virtual printers. However, both virtual printers can send the files to the same physical printer if the latter is capable of printing DIN A3 as well as DIN A4.

The virtual printers are generated in the configuration and processed step-by-step by the PDF kernel during a PrintJob production.

At the start of the production, the kernel is informed about the virtual printer to be used. Then the PrintJob XML file is read in, from which the internal data structures that are needed for the further production are built up.

During the entire production, the production kernel ascertains which side of the letter is on the produced pages of the PDF documents. A CreateTemplatePDF function can be used to generate the static part for the production. For this purpose, empty pages have to be personalized. When these personalized pages are imposed, the kernel ascertains where the individual letters will be positioned. The personalized PDF file can be changed at will. This includes, for example, adding pages, changing the page sequence, adding texts and lines and performing the imposition. Only imposed files may not be imposed once again. Once the personalized PDF file (variable part) has been completely processed, CreateTemplatePDF can be used to generate a matching static PDF file. Here, a PDF file is generated on the basis of the PDF templates of all of the UserJobs and all of the necessary combinations appear once in this PDF file. For the later generation of a job ticket for a production printer, a data structure is built up that describes which variable page fits with which static page.

Attributes of CreateTemplatePDF are, for example, the following:

| Attribute | Function |
|---|---|
| PageWidth | Page width of the PDF template to be generated |
| PageHeight | Page height of the PDF template to be generated |
| VariableFileName | Personalized PDF file for which a static template is to |
| | be generated |

A Condition function can be used as an attribute for some functions so that these are executed under certain conditions. The following instructions evaluate the Condition: “AddText”, “AddLine” and “NewPDF”. The condition under which the instruction should be executed can be specified by indicating a keyword.

The following keywords, for example, can be implemented:

| Keyword | Function |
|---|---|
| doArchive | Is only executed if specimen copies are |
| | to be printed |
| internal_customer | Is only executed if the user of the UserJob |
| | is an internal user. Always yields |
| | false. |
| external_customer | Is only executed if the user of the UserJob |
| | is an external user. Always yields |
| | true. |
| ContainsCurrentInfoPostCriteria | Is executed if there are letters for the |
| | InfoPost criterion set |
| ContainsCurrentInfoPostCriteriaInLoop | Is executed if a set InfoPost criterion is |
| | present within a loop |
| StartOfInfoLetter | Is executed if the start of the InfoLetter |
| | letters is within the loop |
| SingleUserJob | Is executed if only one UserJob is contained in |
| | this PrintJob |
| MultipleUserJobs | Is executed if several UserJobs are contained in |
| | this PrintJob |
| EndOfInfoLetter | Is executed if the end of the InfoLetter |
| | letters is within the loop |
| StartOfInfoPost | Is executed if the start of the InfoPost |
| | letters is within the loop |
| EndOfInfoPost | Is executed if the end of the InfoPost |
| | letters is within the loop |
| StartOfStandard | Is executed if the start of the Standard |
| | letters is within the loop |
| EndOfStandard | Is executed if the end of the Standard |
| | letters is within the loop |
| ContainsInfoLetter | Is executed if the PrintJob contains |
| | InfoLetter letters |
| ContainsInfoPost | Is executed if the PrintJob contains |
| | InfoPost letters |
| ContainsStandard | Is executed if the PrintJob contains |
| | Standard letters |

Within a SendToPrinter function, a rip ticket can be created, the PDF files can be converted and the completed files can be sent to a printer.

A CreateRipTicket function configures how a rip ticket is to be created. As an attribute, the file name has to be set with the destination name. Within CreateRipTicket, several Line descriptions are created in combination with DataLines. The Data attribute is set within Line. All of the texts of Line are written consecutively into the rip ticket file. In doing so, given variables are replaced. Repeat loops and loops can be built in at any desired place.

With a UserJob having the ID 10000105, in which eight variable PDF pages are formed, for example, the following rip ticket file is generated:

; Book Ticket File created by Mailingfactory - SIMPLEX
BOOK book_10000105

“M_10000105”(1) @”V_10000105_0”(1)
“M_10000105”(1) @”V_10000105_0”(2)
“M_10000105”(1) @”V_10000105_0”(3)
“M_10000105”(1) @”V_10000105_0”(4)
“M_10000105”(1) @”V_10000105_0”(5)
“M_10000105”(2) @”V_10000105_0”(6)
“M_10000105”(1) @”V_10000105_0”(7)
“M_10000105”(3) @”V_10000105_0”(8)

ENDBOOK
PRINTRUN pr_10000105

book_10000105, bcopies=1

ENDPRINTRUN

With a Convert function, the PDF files can be converted, for example, into a format such as PostScript. Possible attributes of Convert are:

| Attribute | Function |
|---|---|
| Method | The conversion method |
| ProgramToUse | Name of the conversion program |
| Printer | The printer that is to be used for the conversion into |
| | PostScript |
| DeleteInputFiles | Optional, true or false. Determines whether the input |
| | files are to be deleted after the conversion. |

With a NewPS tag, the print job generation element is instructed to convert a PDF file, for example, into PostScript. Tags are separator characters for command information in HTML. An attribute of NewPS in Convert can be InputFileName:

| Attribute | Function |
|---|---|
| InputFileName | The name of the file that is to be converted |

With a SendFile function, files can be sent directly to a printer. Possible attributes of SendFile are the following:

| Attribute | Function |
|---|---|
| Command | The command with which the file can be sent to the printer |
| FileName | The name of the file that is to be sent to the printer |
| Delete | If this attribute is present, the file is automatically deleted |
| | after begin sent. |

Any number of virtual printers can be set up in the configuration of the print job generation element. With a virtual printer, it is possible to configure which jobs can be processed with this virtual printer and how the documents are to be generated. A virtual printer has, for example, the following set up:

<VirtualPrinter Name=“DP 4635 SIMPLEX”
AddressesPerPly=“200”
Description=“A DIN A4-PDF with addresses and template in one”>
<PrintJobConditions>
.
.
.
</PrintJobConditions>
<PrepareJobDocuments>
.
.
.
</PrepareJobDocuments>
<SendToPrinter>
.
.
.
</SendToPrinter>

The attributes of VirtualPrinter can be, for example, the following:

| Attribute | Function |
|---|---|
| Name | Name of the virtual printer. This is advantageously |
| | displayed in the user interface and should provide |
| | information about the function |
| AddressesPerPly | Number of addresses that are processed per step |
| | during the hidden assignment of the PrintJobs. |
| Description | Can be used to store a more precise description |
| | for later legibility |

With PrintJobConditions, it is possible to regulate which jobs can be produced with this virtual printer. Here, name-value pairs can be indicated, whereby the name must match a UserJobAttribute. The value in Value indicates which value the attribute must have so that the UserJob can be produced with this virtual printer. As soon as a condition does not apply, the UserJob cannot be produced with this virtual printer. UserJob attributes that are not indicated under the PrintJobConditions can be as desired.

Within PrepareJobDocuments, any number of PrepareDocumentSteps can be set up. These steps are carried out consecutively in order to produce the documents.

Within PrepareDocumentStep, it is described how a PDF document is generated. This document can also be used in further steps as the template. Loop, Repeat and NewPDF can be used within PrepareDocumentStep. It is also possible to indicate a module whose content is executed as follows:

<PrepareDocumentStep Name=“Create InfoPostCriteria StartPage”
Module=“StartPage InfoPostCriteria simplex”/>

Modules can also be created on the level of settings and VirtualPrinter. These modules can be referenced by several PrepareDocumentStep entries in various virtual printers.

Within a Loop, all of the commands contained therein are repeated. The number of repetitions is a function of the setting of AddressesPerPly in the virtual printer and of the number of addresses in the PrintJob (NumberOfPieces). The loop is repeated as often as AddressesPerPly fits into NumberOfPieces. If there is a remainder, this is advantageously rounded off.

Loop is used, for example, to execute “hidden JobSplitting”. During a loop pass, a variable LoopNo is set in each step. This variable can be used to generate various document names.

Repeat can be used to execute instructions multiple times. The number of repetitions can be parameterized. During the pass, the variable RepeatNo is set. The attributes of Repeat are, for example, the following:

| Attribute | Function |
|---|---|
| Start | The starting value of RepeatNo |
| Count | The number of passes to be executed |
| Action | Optionally, this can be used to set environmental variables |
| | during each pass, as a function of RepeatNo. The following |
| | are supported, for example: |
| | “SetCompany”-> can be used if a PrintJob stems from several |
| | UserJobs of different companies in order to iterate for |
| | the companies |
| | “SetInfoPostCriteria”-> can be used in order to iterate for the |
| | various InfoPost criteria |
| | “SetCompanyUserJob”-> can be used in order to iterate for |
| | the UserJobs of the Company |

A new PDF document can be generated with NewPDF. Within NewPDF, instructions have to be given as to how the PDF document is to be generated. The following instructions, for example, are possible within NewPDF: “Repeat”, “WorkFlow”, “PersonalizeOnTemplate”, “Personalize”, “CreateTemplatePDF” and “OpenpDF”.

NewPDF can have the following attributes:

| Attribute | Function |
|---|---|
| Filename | Name of the PDF file to be generated |
| Persistence | Indicates whether the file to be generated is to exist only |
| | temporarily or whether it should be retained after the |
| | production has been ended. |
| | Values: |
| | “Temp” -> the file is deleted after the production |
| | “Final” -> the file is retained |
| Condition | Optional, |

It has proven to be especially advantageous to use WorkFlows which describe how a document is to be generated. Within WorkFlows, for example, VariableData, Merge and Impositioning can be allowed. WorkFlow advantageously has no attributes. If several WorkFlows are created consecutively, then they are processed, for example, consecutively, whereby the result of a WorkFlow always serves as the source of the next WorkFlow.

A PersonalizeOnTemplate command causes a new PDF file to be created in which several letters are consecutively located that consist of the PDF template and that are personalized with the data records from the variable data. The number of letters depends on the AddressesPerPly attribute. In order to generate letters for all of the variable data, PersonalizeOnTemplate has to appear within Loop. As a result, several PDF files are formed, each with a number of AddressesPerPly letters. If the number of addresses is not precisely divisible by the AddressesPerPly, then the remaining letters are located in the last PDF file. If there are different UserJobs in the PrintJob, then the PDF template that matches the appertaining address is used automatically.

In order to classify mailpieces, InfoPost criteria are normally specified that can comprise, for example, InfoLetter, InfoPost or Standard. If such an InfoPost criterion is set during the personalization, then only addresses that have the corresponding InfoPost criterion are processed.

An example of this is shown below:

```
<PrepareDocumentStep Name=“Personalize on Template”>
  <Loop>
    <Repeat Count=“3” Action=“SetInfoPostCriteria” Start=“1”>
      <NewPDP
Filename=“${TEMPPATH}\
new_${JobID}_${LoopNo}_Pers_${RepeatNo}”
Persistence=“Temp”>
      <PersonalizeOnTemplate StartPage=“1” PageWidth=“210”
PageHeight=“297”/>
      </NewPDF>
    </Repeat>
  </Loop>
</PrepareDocumentStep>
```

By means of the instructions above, several PDF files are formed in Temppath with the new_ID_x_Pers_y name and having the following meaning:
X: index for recognizing the partial packet. Runs from 0 to “InitialNumberOfPieces”/“AddressesPerPly” (rounded off).
Y: The appertaining InfoPost criterion. 1: InfoLetter; 2: InfoPost; 3: Standard.

The sum of all letters from the various InfoPost criteria at a value of X equals AddressesPerPly or rather the remainder of the division.

It is also advantageous to have a Personalize function that functions like PersonalizeOnTemplate, except that the personalization is not carried out on the PDF template but rather on a new empty document. Attributes of “personalize” can be the following, for example:

| Attribute | Function |
|---|---|
| PageWidth | Page width of the PDF file to be newly generated |
| PageHeight | Page height of the PDF file to be newly generated |

An OpenPDF function causes a PDF file to be opened. In the case of further instructions, this file serves as a source. An attribute of OpenPDF is, for example, Filename:

| Attribute | Function |
|---|---|
| FileName | The complete file name with the path to the file to be opened |

It is also advantageous that, with VariableData, additional data can be applied to a PDF document. Here, the current document which was either opened by OpenPDF, stemmed from the preceding WorkFlow, or else was most recently created during the momentary WorkFlow then serves as the template. For this purpose, a page range has to be indicated. On this page range, the commands stored within VariableData are executed. “AddText”, “AddSDL”, AddLine” and “AddOMR” are possible within VariableData.

Attributes of VariableData are, for example:

| Attribute | Function |
|---|---|
| Name | Can be used for designation |
| StartPage | Start pages of the page range which is to be worked on |
| EndPage | End page of the page range which is to be worked on |
| Step | The step increment for the page range. If, for example, only |
| | every other page is to be processed, then Step = 2 |

Functions such as StartPage and EndPage can also be used for mathematical instructions. For example, the following symbols can be supported:

| Symbol | Function |
|---|---|
| ( ) | Bracketing |
| * | Multiplication |
| / | Division |
| + | Addition |
| − | Subtraction |
| % | Modulo |
| first | Keyword for the first page ->1 |
| last | Keyword for the last page of the document |

Here, EndPage=“last/2+1”, for example, causes the pages to be processed up to the middle of the even-numbered pages.

Within VariableData, an AddText function can be used in order to add a text:

| Attribute | Function | | |
|---|---|---|---|
| Data | Text string that is to be inserted | | |
| Rotation | Text orientation. Possible values are, for example, 0, 90, | | |
| | 180, 270 | | |
| Color | Color in which the text is to be depicted. Possible values: | | |
| | black, blue, red, green, cyan, magenta, yellow, white | | |
| FontSize | The font size in points | | |
| xPos | Text starting point in the horizontal direction, measured | | |
| | from the left-hand edge. Unit: mm | | |
| yPos | Text starting point in the vertical direction, measured from | | |
| | the bottom edge. Unit: mm | | |
| Font | The font in which the text is to be depicted, for example: | | |
| | TimesRoman | Helvetica | CourierSymbol |
| | TimesBold | HelveticaBold | CourierBold |
| | TimesItalic | HelveticaOblique | CourierOblique |
| | TimesBoldItalic | HelveticaBoldOblique | |
| | | CourierBoldOblique | |
| | ZapfDingbats | | |

| | |
|---|---|
| ReplaceData | “TRUE” or “FALSE”. Determines if the text is to be |
| | parsed, so that variables are recognized and are replaced by |
| | their values. |
| Condition | Optional, |
| CharSpacing | Optional, indicates how many blank characters are to be |
| | inserted between all of the characters within the text string |
| MaxLength | Optional, limits the text string to the indicated number of |
| | characters. |

A function AddLine can be used within VariableData in order to add a line between two points:

| Attribute | Function |
|---|---|
| xStart | Starting point of the line in the horizontal direction, |
| | measured from the left-hand edge. Unit: mm |
| yStart | Starting point of the line in the vertical direction, measured |
| | from the bottom edge. Unit: mm |
| xEnd | End point of the line in the horizontal direction, measured |
| | from the left-hand edge. Unit: mm |
| yEnd | End point of the line the vertical direction, measured from |
| | the bottom edge. Unit: mm |
| Thickness | Thickness of the line in mm |
| Color | Color in which the line is to be depicted. Possible values: |
| | black, blue, red, green, cyan, magenta, yellow, white |
| Condition | Optional |

An AddOMR function can be used within VariableData in order to add OMR control characters on pages:

| Attribute | Function |
|---|---|
| xPos | Starting point (top/left) of the control characters in the |
| | horizontal direction, measured from the left-hand edge. Unit: |
| | mm |
| yPos | Starting point (top/left) of the control characters in the vertical |
| | direction, measured from the bottom edge. Unit: mm |
| Sequence | Determines the mode of counting of the sheet sequence (SS) |
| | lines. The following are supported: 0-7, 1-7, 7-1 and 7-0. If, |
| | for example, 0-7 is used, then the sheet sequence lines |
| | consecutively assume the following values: |
| | SS1: 0 1 0 1 0 1 0 1 |
| | SS2: 0 0 1 1 0 0 1 1 |
| | SS4: 0 0 0 0 1 1 1 1 |
| LineWidth | Line width of the control characters in mm |
| Width | Line length of the control characters in mm |

Here, a “line” tag has to be added for each control character line within AddOMR.

| Attribute | Function | |
|---|---|---|
| Name | Can be used to describe the line function | |
| Position | The position within the lines. The first position is at the place | |
| | determined by xPos and yPos. Subsequent positions are each | |
| | ⅙ inch further in the direction of the lower edge. The | |
| | positions have to be counted continuously. | |
| Function | Describes the function of the lines. The following functions | |
| | can be supported: | |
| | ON: | the line appears on all of the pages |
| | OFF: | the line appears on none of the pages |
| | SS1: | for counting the sheet sequence |
| | SS2: | for counting the sheet sequence |
| | SS4: | for counting the sheet sequence |
| | EVEN: | forms an even parity |
| | ODD: | forms an odd parity |
| | LAST: | is set on the last page of the letter |
| | NOTLAST: | is set on all of the pages except for the last |
| | | page of the letter |
| | DGR: | DGR function |
| | DZ: | DZ function |

An EmptyPageInsert function inserts, for example, one or more new empty pages. Possible attributes are:

| Attribute | Function |
|---|---|
| PageWidth | Width of the new page |
| PageHeight | Height of the new page |
| PageNo | Page number of the momentary document where the |
| | empty page/pages is/are to be inserted. |
| Position | “After” or “Before”. Indicates whether the page/pages |
| | is/are to be inserted before or after the PageNo |
| NumberOfPages | Numbers of the empty pages that are to be inserted |

Various PDF files can be merged by means of a Merge function:

| Attribute | Function |
|---|---|
| Name | Can be used to name a merge |
| StartPage | Indicates the place where another document is to be inserted |
| | into the momentary document. |
| EndPage | This attribute is important when pages are taken from the |
| | momentary document and from other documents |
| | alternately. |
| Step | 0, if the new document is to be inserted completely into the |
| | indicated place, otherwise this step increment causes a page |
| | to be taken alternately from the current document and from |
| | the inserted document. |
| Position | “After” or “Before”. Indicates whether the documents are to |
| | be inserted before or after the page designated by StartPage |
| Overlay | “true” or “false” |
| Description | Can be used to precisely describe a merge procedure |

Within Merge, the documents that are to be inserted are advantageously indicated with InsertPDF. Attributes of InsertPDF can be, for example, the following:

| Attribute | Function |
|---|---|
| NewStartPage | Start page of the range of this document that is to |
| | be inserted |
| NewEndPage | End page of the range of this document that is to be |
| | inserted |
| NewStep | Can be used to insert every x^{th} page. For example, |
| | New-Step = “2” -> every other page from the range |
| | is inserted. |
| FileName | Name of the file that is to be inserted |
| DeleteAfterInsert | “TRUE” or “FALSE”, determines whether the file is |
| | to be deleted after being inserted |

An Impositioning function is advantageous in order to determine how a document is to be imposed. Within Impositioning, any desired number of pages can be described. The page description specifies which pages from the original document are positioned on the new pages. The page description is preferably passed several times, whereby in each case, the original page to be taken is calculated once again. The number of passes depends on the values in Signature, Increment and on the number of original pages. It is preferably passed as often as the number of pages fits into Signature*Increment (rounded off).

Possible attributes for Impositioning are the following:

| Attribute | Function |
|---|---|
| PageWidth | Page width for the new document |
| PageHeight | Page height for the new document |
| Increment | Step Increment for the page counter |
| Signature | Determines the number of passes. If a single use is to be |
| | produced, Signature has to be the number of original pages |
| | on a new page. |

In this context, attributes for AddPage are:

| Attribute | Function |
|---|---|
| StartPage | The original page that is positioned during the first pass |
| CountDirection | “positive” or “negative”, determines whether the |
| | value indicated for Increment is added or subtracted |
| | during each of the passes. |
| xPos | Determines where in the horizontal direction the original |
| | page is positioned on the new page. Distance measured in |
| | mm from the left-hand edge. |
| yPos | Determines where in the vertical direction the original |
| | page is positioned on the new page. Distance |
| | measured in mm from the bottom edge. |
| Rotation | “0”, “90”, “180” or “270”. Determines the orientation |
| | of the original page on the new page. |
| xScale | Serves for the horizontal scaling. At “1”, the original |
| | size is retained, at “2”, the size is doubled. |
| yScale | Serves for the vertical scaling. At “1”, the original size is |
| | retained, at “2”, the size is doubled. |

Different variables can be accessed within the configuration of the print job generation element. These variables can be used to generate a document name and different texts in new documents. The variables are set at the beginning of or during the production, depending on their function.

For purposes of local data management, it is advantageous to have a QueueManager in the printing system 10 according to the invention with an installed print job generation element 15. It manages the necessary information such as, for instance, status, files and/or attributes, for all UserJobs and PrintJobs. For this purpose, the QueueManager preferably uses a hierarchical data structure. Every time there is a change, this data structure is stored by the QueueManager on a storage medium such as a hard disk so that all of the information is still available after a new start of the system. The path can be configured, for example, via a QueueManagerPath attribute in a configuration file (PSSConfiguration.xml). In the path, the QueueManager creates a path for each of the UserJobs and PrintJobs in which the corresponding XML files are stored.

An example of a QueueManager is shown below. The outermost container is always called QueueManager. In it, there are two containers: PrintJobs for all PrintJobs and UserJobs for all UserJobs.

```
QueueManager={
  Print Jobs={
    10000179_1={
      PageCountSum=100;
      Status=Waiting;
      LogicalProduct=MF_MAILING_PDF;
      CreationDate=05/28/2002;
    CurrentPrinter=4C − IC100 simplex/enveloping Duisburg;
      UserJobs={
        UserJob1=10000179;
      } // End of UserJobs
      AvailablePrinter={
        4C − IC100 simplex/enveloping Duisburg={
          PRINT_MODE=SIMPLEX;
          PAGE_FORMAT=DIN A4;
          PRINT_COLOR=4C;
          CONTROL_DATA_ALLOWED=TRUE;
          ORIENTATION=PORTRAIT;
        } // End of 4C − IC100 simplex/enveloping Duisburg
        Merged in one PDF SIMPLEX={
          PRINT_MODE=SIMPLEX;
          PAGE_FORMAT=DIN A4;
          CONTROL_DATA_ALLOWED=TRUE;
          ORIENTATION=PORTRAIT;
        } // End of Merged in one PDF SIMPLEX
      } // End of AvailablePrinter
      Plys={
      Ply1={
        Status=Waiting;
      } // End of Ply1
    } // End of Plys
  } // End of 10000179_1
} // End of Print Jobs
User Jobs={
  10000179={
    CurrentPrinter=4C − IC100 simplex/enveloping Duisburg;
    CreationDate=05/27/2002;
    Id=10000179;
    LastChangeDate=05/28/2002;
    LogicalProduct=MF_MAILING_PDF;
    PageCountSum=100;
    Downloaded=TRUE;
    PageCountLetter=1;
    Status=Waiting;
    AddressCount=100;
    Percentage=10;
    DownloadedDate=05/28/2002;
    JobAttributes={
      PARTNER_DOWNLOAD_TIMESTAMP=05/27/2002 16:28:46;
      PRINT_COLOR=4C;
      PRINT_MODE=SIMPLEX;
      POSTAGE_INFOLETTER_STANDARDLETTER=100;
      CURRENT_PARTNER_ID=5000000;
      POSTAGE_INFOPOST_STANDARDLETTER=0;
      PROJECT_ID=5160036;
      PARTNER_COMPLETION_PERCENTAGE=10;
      POSTAGE_START_DATE=05/27/2002 14: 02:406;
      PARTNER_LAST_UPDATE=05/27/2002 16:28:46;
      RANGE_OF_PAGES=1-3;
      CURRENT_PARTNER_INSTANCE=OLS;
      POSTAGE_INFOLETTER_ADD_STANDARDLETTER=0;
      TOTAL_NUMBER_OF_PAGES=100;
      NUMBER_OF_PAGES=1;
      INITIAL_NUMBER_OF_PIECES=100;
      GROSS_WEIGHT=9.16656;
      ORIENTATION=PORTRAIT;
      POSTAGE_STANDARD_STANDARDLETTER=0;
      POSTAGE_INFOPOST_ADD_STANDARDLETTER=0;
      PAGE_FORMAT=DIN A4;
    } // End of JobAttributes
    Print Jobs={
      PrintJob1=10000179_1;
    } // End of Print Jobs
    AvailablePrinter={
      4C − IC100 simplex/enveloping Duisburg={
        PRINT_MODE=SIMPLEX;
        PAGE_FORMAT=DIN A4;
        PRINT_COLOR=4C;
        CONTROL_DATA_ALLOWED=TRUE;
        ORIENTATION=PORTRAIT;
      } // End of 4C − IC100 simplex/enveloping Duisburg
      Merged in one PDF SIMPLEX={
        PRINT_MODE=SIMPLEX;
        PAGE_FORMAT=DIN A4;
        CONTROL_DATA_ALLOWED=TRUE;
        ORIENTATION=PORTRAIT;
        } // End of Merged in one PDF SIMPLEX
      } // End of AvailablePrinter
    } // End of 10000179
  } // End of User Jobs
} // End of QueueManager
```

An example of a data structure that the QueueManager creates for a UserJob can be seen in the following table:

UserJobID
CurrentPrinter=
CreationDate=
Id=
LastChangeDate=
LogicalProduct=
PageCountSum=
Downloaded=
PageCountLetter=
Status=
AddressCount=
Percentage=
DownloadedDate=

| JobAttributes | PrintJobs | AvailablePrinter | | |
|---|---|---|---|---|
| JobAttribute1= | PrintJob1= | Printer1 | ... | PrinterN |
| . | . | Attribute1= | . | Attribute1= |
| . (all UserJob | . (all PrintJobs) | . | . . | |
| attributes) | . | . | . | . |
| . | PrintJobN= | AttributeN= | . | AttributeN= |
| JobAttributeN= | | | | |

During the synchronization with the SOAP server, the attributes are queried by new UserJobs. With these attributes, the QueueManager creates a new UserJob. In this process, the following approach, for example, is taken:
generation of the new UserJob container
ID attribute is set with UserJobID
status attribute is set at READY_FOR_DOWNLOAD
Percentage attribute is set at 0
LogicalProduct is set at the appropriate value
Downloaded is set at FALSE
LastChangeDate is set at the current time of day
the UserAttribute container is added
an empty PrintJobs container is added
AddressCount is set on the basis of the UserJob information
CreationDate is set on the basis of the job information
PageCountLetter is set on the basis of the job information
PageCountSum is set on the basis of the job information
the AvailablePrinter container is added.

Possible virtual printers result from the configuration in a PSSConfiguration. All printers are inserted whose PrintJobConditions do not exclude attributes of the UserJob. The PrintJobConditions are stored for each printer in the structure. If, in the further course, one of more PrintJobs are generated on the basis of the UserJob, then the appropriate UserJobIDs are entered in the PrintJobs container. For each change, for example, in case of status changes, the LastChangeDate attribute is reset by the QueueManager. If the UserJob is downloaded, then DowloadedDate is set and the downloaded XML file is stored in the UserJob path.

An example of a data structure that the QueueManager creates for a PrintJob can be seen in the following table:

PrintJobID
PageCountSum=
Status=
LogicalProduct=
CreationDate=
CurrentPrinter=
StartAddress=
EndAddress=

| UserJobs | AvailablePrinter | | | Plys | |
|---|---|---|---|---|---|
| UserJob1= | Printer1= | ... | PrinterN | Ply1 | ... PlyN |
| . | | | | | |
| . (UserJob in this | Attribute1= | . | Attribute1= | Status= | ... Status= |
| PrintJob) | . | . | . | | |
| . | . | . | . | | |
| UserJobN= | AttributeN= | . | AttributeN= | | |

If a PrintJob is created from one or more UserJobs, then the QueueManager creates the appropriate PrintJob container. In this process, the following approach, for example, is taken:
one or more PrintJob XML files are generated on the basis of the UserJob XML files
the PrintJob container is created
Status is set at WAITING
LogicalProduct is set, whereby the value is specified by the UserJob(s)
the UserJob container is created and all UserJobs from which this PrintJob is formed are entered
the AvailablePrinter container is copied and inserted by the UserJob
If several PrintJobs are to be generated on the basis of one UserJob, then StartAddress and EndAddress are set (the address range for this PrintJob)
PageCountSum is set (number of all printed pages in the PrintJob)
CurrentPrinter is set at the selected printer
the number of plys over which the PrintJob is to be divided is ascertained (results from the letters to be printed and from the AddressesPerPly attributes of the printer in the configuration)
The plys container is generated accordingly and all of the plys are set at WAITING
CreationDate is set at the momentary time of day.

For each subsequent change in the PrintJob status, the LastChangeDate and the corresponding Percentage are updated.

When a PrintJob is generated, a new PrintJob XML file is created on the basis of the UserJob XL files. This function is carried out, for example, by a RecreateXML class.

The UserJob XML file contains, for example, UserJob attributes, company data, item data and UserJob files. In an especially preferred embodiment of the invention, the UserJob files are Base64-encoded. Base64 is an encoding that is used by the MIMENCODE program in MIME standard to convert binary data into an ASCIT subset.

The RecreateXML class comprises all of the UserJobs into one JOBTRANSFER-ENVELOPE. The UserJob attributes, company data and item data are taken over unchanged by each UserJob. The files with the print instructions and the variable data are changed by RecreateXML. The remaining files are taken over.

If a UserJob is divided into several PrintJobs, the variable data is divided into records. Each PrintJob receives one of these records.

The print instructions of the UserJobs can have the following format, for example:

```
<?xml version=“1.0” encoding=“ISO-8859-1” ?>
    <USERJOB_HANDLING_INSTRUCTIONS Version=“2.1”>
  <DATA_FIELD_DESCRIPTION>
    <DATA_FIELD NAME=“Company_1” ABBREV=“d00”/>
    <DATA_FIELD NAME=“Adr_Salutation” ABBREV=“d01”/>
    <DATA_FIELD NAME=“Salutation” ABBREV=“d02”/>
    <DATA_FIELD NAME=“FirstName” ABBREV=“d03”/>
    <DATA_FIELD NAME=“LastName” ABBREV=“d04”/>
    <DATA_FIELD NAME=“Street” ABBREV=“d05”/>
    <DATA_FIELD NAME=“PostalCode” ABBREV=“d06”/>
    <DATA_FIELD NAME=“City” ABBREV=“d07”/>
    </DATA_FIELD_DESCRIPTION>
    <FORMATTER_INSTRUCTIONS Version=“1.0”>
          <CONTENT_ASSIGNMENT
  CONTENT_ID=“CompanyLine1”
DATA_FIELD_NAME=“Company_1”/>
          <CONTENT_ASSIGNMENT CONTENT_ID=“Title”
DATA_FIELD_NAME=“Adr_Salutation”/>
          <CONTENT_ASSIGNMENTCONTENT_ID=“FirstName”
DATA_FIELD_NAME=“FirstName”/>
          <CONTENT_ASSIGNMENTCONTENT_ID=“LastName”
DATA_FIELD_NAME=“LastName”/>
          <CONTENT_ASSIGNMENTCONTENT_ID=“StreetWithNo”
DATA_FIELD_NAME=“Street”/>
    <CONTENT_ASSIGNMENT CONTENT_ID=“PostalCode”
  DATA_FIELD_NAME=“POSTALCODE”
/>
```

<CONTENT_ASSIGNMENT CONTENT_ID=“City”

DATA_FIELD_NAME=“City”/>

<EMPTYLINEBEFORECITY OBLIGATORY=“FALSE”/>
<SALUTATIONLINE LINESUFFIX=“,” PATTERN_ID=“6”/>
</FORMATTER_INSTRUCTIONS>
<PRINTING_INSTRUCTIONS>
<PRINTFIELD_MAPPING>
<PRINTFIELD NAME=“LINE1” SPACETRIMMING=“FALSE”>
<FORMATTER_FIELD SEQ=“1” NAME=“LetterHead_Row_1”/>
</PRINTFIELD>
<PRINTFIELD NAME=“LINE2” SPACETRIMMING=“FALSE”>
<FORMATTER_FIELD SEQ=“1” NAME=“LetterHead_Row_2”/>
</PRINTFIELD>
<PRINTFIELD NAME=“LINE3” SPACETRIMMING=“FALSE”>
<FORMATTER_FIELD SEQ=“1” NAME=“LetterHead_Row_3”/>
</PRINTFIELD>
<PRINTFIELD NAME=“LINE4” SPACETRIMMING=“FALSE”>
<FORMATTER_FIELD SEQ=“1” NAME=“LetterHead_Row_4”/>
</PRINTFIELD>
<PRINTFIELD NAME=“LINE5” SPACETRIMMING=“FALSE”>
<FORMATTER_FIELD SEQ=“1” NAME=“LetterHead_Row_5”/>
</PRINTFIELD>
<PRINTFIELD NAME=“LINE6” SPACETRIMMING=“FALSE”>
<FORMATTER_FIELD SEQ=“1” NAME=“LetterHead_Row_6”/>
</PRINTFIELD>
<PRINTFIELD NAME=“LINE7” SPACETRIMMING=“FALSE”>
<FORMATTER_FIELD SEQ=“1” NAME=“LetterHead_Row_7”/>
</PRINTFIELD>
<PRINTFIELD NAME=“SENDER” SPACETRIMMING=“FALSE”>
<STATIC_FIELD SEQ=“1” VALUE=“DIRON Wirtschaftsinformatik GMBH

& Co.KG
- Daimlerweg 39-41 - 48163 Munster, Germany”/>

</PRINTFIELD>
<PRINTFIELD NAME=“SALUTATION” SPACETRIMMING=“FALSE”>
<FORMATTER_FIELD SEQ=“1” NAME=“SalutationLine”/>
</PRINTFIELD>
</PRINTFIELD_MAPPING>
<PRINTFIELD_POSITIONS>

<POSITION POSX=“25”POSY=“250” FONT=“HELVETICA”
FONTSIZE=“10”

| | |
|---|---|
| COLOR=“BLACK” | PAGEFROM=“1”PAGETO=“1” NAME=“LINE1”/> |
| <POSITION | POSX=“25”POSY=“246” FONT=“HELVETICA” |
| FONTSIZE=“10” | |
| COLOR=“BLACK” | PAGEFROM=“1”PAGETO=“1” NAME=“LINE2”/> |
| <POSITION | POSX=“25”POSY=“242” FONT=“HELVETICA” |
| FONTSIZE=“10” | |
| COLOR=“BLACK” | PAGEFROM=“1”PAGETO=“1” NAME=“LINE3”/> |
| <POSITION | POSX=“25”POSY=“238” FONT=“HELVETICA” |
| FONTSIZE=“10” | |
| COLOR=“BLACK” | PAGEFROM=“1”PAGETO=“1” NAME=“LINE4”/> |
| <POSITION | POSX=“25”POSY=“234” FONT=“HELVETICA” |
| FONTSIZE=“10” | |
| COLOR=“BLACK” | PAGEFROM=“1”PAGETO=“1” NAME=“LINE5”/> |
| <POSITION | POSX=“25”POSY=“230” FONT=“HELVETICA” |
| FONTSIZE=“10” | |
| COLOR=“BLACK” | PAGEFROM=“1”PAGETO=“1” NAME=“LINE6”/> |
| <POSITION | POSX=“25”POSY=“226” FONT=“HELVETICA” |
| FONTSIZE=“10” | |
| COLOR=“BLACK” | PAGEFROM=“1”PAGETO=“1” NAME=“LINE7”/> |
| <POSITION | POSX=“25”POSY=“189” FONT=“HELVETICA” |
| FONTSIZE=“10” | |
| COLOR=“BLACK” | PAGEFROM=“1” PAGETO=“1” |
| NAME=“SALUTATION”/> | |
| <POSITION | POSX=“25”POSY=“260” FONT=“HELVETICA” |
| FONTSIZE=“6” | |
| COLOR=“BLACK” | PAGEFROM=“1” PAGETO=“1” |

NAME=“SENDER”/>
</PRINTFIELD_POSITIONS>
</PRINTING_INSTRUCTIONS>
</USERJOB_HANDLING_INSTRUCTIONS>

RecreateXML preferably uses an address formatter on the basis of which it generates print instructions that are understood by the PDF kernel. The print instructions for the above-mentioned file in the PrintJob file look, for example, like this:

```
<VariableData StartPage=“1” Step=“1” EndPage=“1”>
  <ADDTEXT RECORD=“LINE1” yPos=“250” Color=“BLACK” FontSize=“10”
xPos=“25”
Font=“HELVETICA”/>
  <ADDTEXT RECORD=“LINE2” yPos=“246” Color=“BLACK” FontSize=“10”
xPos=“25”
Font=“HELVETICA”/>
  <ADDTEXT RECORD=“LINE3” yPos=“242” Color=“BLACK” FontSize=“10”
xPos=“25”
Font=“HELVETICA”/>
  <ADDTEXT RECORD=“LINE4” yPos=“238” Color=“BLACK” FontSize=“10”
xPos=“25”
Font=“HELVETICA”/>
  <ADDTEXT RECORD=“LINE5” yPos=“234” Color=“BLACK” FontSize=“10”
xPos=“25”
Font=“HELVETICA”/>
  <ADDTEXT RECORD=“LINE6” yPos=“230” Color=“BLACK” FontSize=“10”
xPos=“25”
Font=“HELVETICA”/>
  <ADDTEXT RECORD=“LINE7” yPos=“226” Color=“BLACK” FontSize=“10”
xPos=“25”
Font=“HELVETICA”/>
  <ADDTEXT RECORD=“SALUTATION” yPos=“189” Color=“BLACK”
FontSize=“10”
xPos =“25” Font=“HELVETICA”/>
  <ADDTEXT RECORD=“SENDER” yPos=“260” Color=“BLACK” FontSize=“6”
xPos=“25” Font=“HELVETICA”/>
</VariableData>
```

In the UserJob XML file, the variable data looks, for example, like this:

<USERJOB_VARIABLE_DATA>

<RECORD SORT_ID=“5” TYPE=“1” SEQ=“5”>
<d07>City </d07>
<d06>PostalCode/d06>
<d05>System</d05>
<d04>LastName</d04>
<d03>FirstName</d03>
<d02>Mr.</d02>
<d01>Mr. FirstName LastName</d01>
<d00>Company</d00>
</RECORD>
.
.
.

</USERJOB_VARIABLE_DATA>

Using the allocation in the Print Instruct file, Recreate XML generates the following on this basis:

```
<THE_DATA>
    <RECORD SORT_ID=“5” SEQ=“5”>
    <LINE4>PostalCode City</LINE4>
    <LINE3>System</LINE3>
    <LINE2>Mr. FirstName LastName</LINE2>
    <LINE1>Company</LINE1>
  <SENDER>Sender</SENDER>
    <LINE7/>
    <SALUTATION>Dear Mr. FirstName LastName,</SALUTATION >
    <LINE6/>
    <LINE5/>
  </RECORD>
</THE_DATA>
```

In this manner, the personalization during the production yields the data that is available in a form in which the PDF kernel can use it directly.

The QueueManager administers the status for all UserJobs, PrintJobs and Plys. The QueueManager is notified of status changes by a data model of an interface. Here, for example, the following status can occur:

| Status | Display in the interface |
|---|---|
| Intervention_Required | Intervention required |
| Not_Producible | Production not possible |
| Waiting | Waiting |
| Downloaded | Downloaded |
| Failed | Production failed |
| Ready_For_Download | Downloadable |
| Canceled | Canceled |
| Preprocessing | In pre-production |
| Preprocessed | Pre-processed |
| Printed | Printed |
| Delivered | Delivered |

It has also proven to be advantageous for the QueueManager to set a Percentage attribute in case of status changes with the UserJobs and PrintJobs. This attribute indicates the completion of the UserJob in terms of a percentage. This value is transmitted for each UserJob during the synchronization with the server 20. The status of the UserJob and PrintJob in conjunction with the percentage of the completion are shown in the following table:

| | Status of the | |
|---|---|---|
| UserJob Status | associated PrintJobs | Percentage of completion |
| Intervention_Required | — | 10 |
| Not_Producible | — | 0 |
| Waiting | Waiting | 10 |
| Downloaded | — | 5 |
| Failed | | |
| Ready_For_Download | — | 0 |
| Canceled | | Last value before |
| | | cancellation |

| | | |
|---|---|---|
| Preprocessing | Preprocessing | 10 |
| Preprocessed | Preprocessed | 10 |
| Preprocessed | Preprocessed/Printed | 10-95, depending on the |
| | | number of completed |
| | | PrintJobs |
| Printed | Printed | 95 |
| Delivered | Delivered | 100 |

It is especially advantageous if users of the print job generation element 15 according to the invention can use a user interface to oversee and control the production within a printing system 10. The interface can be implemented, for example, by using Java Swing. The data for the interface is administered, for example, by a DataModel class that queries the QueueManager in order to ascertain values.

It is also advantageous for a user to be able to log in, log out and end the program via a menu in the SOAP server. These functions are preferably made available in a toolbar. During log-in, for example, a dialog box can be opened in which the user name and the password are to be entered. With this information, the system attempts to log into the SOAP server via an AuthenticateUser method from the ServerProxy. If the log-in is successful, then the user information is stored in the data model. This user information is employed for further communication with the server. In case of an error, it as advantageous for a dialog box with an error message to appear.

It is advantageous to implement a “log-out” function that deletes user information from the data model so that no communication is possible with the server without logging in once again. Another “log-out and end” function checks, for example, if production threads are still running. If there are still threads, another query is launched asking whether the program is to be ended. The program is ended, for example, with System.exit(0).

Via a ComboBox, for example, three different views of the UserJobs can be created. For all views, there are inner model classes in the main frame class (FrnApplication). The main frame initializes several ChangeListeners that set the possible actions in case of a change in the UserJob selection and in case of a UserJob status change. The possible actions are queried from the data model. The data model derives the possible actions from the status of the selected UserJobs that is queried by the QueueManager.

Via the UserJob menu, UserJobs can be downloaded, converted into PrintJobs, canceled, set at not-producible, reset and produced with a wizard. All actions can be launched via a toolbar. The possible actions depend on the status of the selected UserJobs.

The allocations between UserJob status and possible action are compiled in the following table:

| Status of the | |
|---|---|
| selected UserJobs | Possible actions |
| Downloadable | Download, production wizard |
| Downloaded | Create new PrintJob (if all of the selected UserJobs are |
| | allowed to be combined into one PrintJob), cancel, |
| | production wizard |
| Waiting | — |
| Pre-produced | — |
| Printed | — |
| Delivered | — |
| Intervention | UserJob not producible |
| required | |
| Production failed | — |
| Canceled | Reset |

The consequences of the UserJob actions are compiled in the following table:

| Action | Consequence |
|---|---|
| Downloading | The selected UserJobs are downloaded from the |
| | PartnerServerProxy in their own thread by calling the |
| | ExportUserJob method. The QueueManager is notified |
| | that the UserJobs have been downloaded |
| Create new | One or more PrintJobs are generated on the basis of the |
| PrintJob | selected UserJobs. This gives rise to new XML files in |
| | which the UserJob files are decoded and converted |
| | with the Recreate XML class into a new XML format |
| | that can be read by the PDF kernel. Then the |
| | QueueManager is notified as to which UserJobs |
| | became which PrintJobs. |
| UserJob not | The type of error and a comment are requested. The |
| producible | Queue-Manager is notified. |
| Production | The wizard is started, which downloads all of the |
| wizard | selected UserJobs, generates a PrintJob in each case |
| | and then produces it. |
| Canceling | The QueueManager is notified that the selected UserJobs |
| | are to be canceled. |

The use of a production wizard is especially advantageous. The production wizard groups all of the selected UserJobs according to products. If no UserJob was selected, then all UserJobs are used. For purposes of grouping, the wizard uses, for example, the PRINT_MODE, PRINT_COLOR and PRINT_FORMAT attributes. The following table shows the wizard products and their attributes:

| Wizard | | | |
|---|---|---|---|
| product | PRINT_MODE | PRINT_COLOR | PRINT_FORMAT |
| Colored, | SIMPLEX | 4C | DIN A4 |
| simplex | | | |
| Colored, | DUPLEX | 4C | DIN A4 |
| duplex | | | |
| b/w, simplex | SIMPLEX | b/w | DIN A4 |
| b/w, duplex | DUPLEX | b/w | DIN A4 |
| Funcard | — | — | DIN A6 |

The view of the PrintJobs can likewise be made selectable via a ComboBox. The views and the action handling are implemented as with the UserJobs, but with the difference that the values for PrintJobs are queried by the QueueManager.

The possible actions depend on the status of the selected PrintJobs. The allocation between PrintJob status and possible action is compiled in the following table:

| Status of the | |
|---|---|
| selected PrintJobs | Possible actions |
| Waiting | Producing, resolving, changing printer |
| Pre-produced | Print repetition, resolving, resetting |
| Printed | Print repetition, delivering, resolving |
| Intervention | Produce, resolving, resetting |
| required | |

The following table shows the consequences of the PrintJob actions:

| Action | Consequence |
|---|---|
| Producing | The PDF kernel is instructed to produce the PrintJob. The |
| | QueueManager is notified of the result of the production. |
| Print | The PDF kernel is instructed to produce part of the PrintJob. |
| repetition | The QueueManager is notified of the result of the production. |
| Delivering | The QueueManager is notified that the PrintJob was delivered. |
| Changing | The QueueManager is notified to set the printer. The only |
| printer | printers offered for selection are those on which the PrintJob |
| | is producible. The printers are queried by the Queue- |
| | Manager. |
| Resetting | The QueueManager is notified to reset the PrintJob. |

An advantageous embodiment of the invention is also that a user can perform synchronization via a server menu and reset the local cache.

If a synchronization is performed, the print job generation element first uses the ServerProxy to send to the server every status and the degree of completion as a percentage value of the local UserJobs. If a UserJob has the status CANCELED, FAILED or DELIVERED, the QueueManager is subsequently instructed to delete these local jobs. After the status transmission, the print job generation element queries all downloadable “exportable” UserJobs. If a downloadable UserJob is not yet present locally, then the QueueManager is instructed to create it. Then the attributes of this new UserJob are queried by the server and the QueueManager is notified. If an error occurs during the querying of the attributes, the QueueManager is instructed to set this UserJob at NOT_PRODUCIBLE.

In the next step, the print job generation element queries the list of already downloaded UserJobs from the SOAP server. If UserJobs that were already downloaded are no longer present locally, the UserJobs are newly created via the QueueManager and downloaded. This can take place, for example, if the local files of the QueueManager are deleted. If there are local UserJobs that are not in the list of downloaded UserJobs, then these UserJobs are deleted locally.

When the local cache is reset, to start with, all of the PrintJobs are eliminated. Then all of the files that are managed by the QueueManager are deleted. After the restart of the QueueManager that now takes place, a synchronization is performed in which, however, the transmission of the status to the SOAP server does not occur.

In an especially preferred embodiment of the invention, all of the errors that occur within the print job generation element are displayed to the user in a dialog box. Moreover, the errors and the date are preferably stored in a log file. The file is called, for example, error.log and it is located in a path that is indicated in the configuration under errorpath.

Preferably, all of the information used for the production is stored in a JobEnvironment. Here, to start with, all of the UserJobs contained in the PrintJob are stored in data objects of a UserJobData class. These data objects offer access to all of the UserJob data that is of importance for the production. In order for the total number to become known, the number of addresses, pages and sheets for all of the UserJobs is added and stored.

JobEnvironment analyzes how many letters are intended for each InfoPost criterion, namely, InfoLetter, InfoPost or Standard. A data object of a Letter class is generated on the basis of each address. For the further production sequence, JobEnvironment makes methods available in order to query certain information via the UserJob.

The Letter class contains information for a letter. This includes, for example, personalization information, the number of letter pages, the InfoPost criterion, the UserJobID and the position within the UserJob. The JobEnvironment manages a list with letter objects for all letters.

Preferably, an object of the UserJobData class contains all data of a UserJob. This includes all UserJob attributes as well as information about postage, price and company. The JobEnvironment has a list of UserJobs with all of the UserJobData objects of the job. The UserJobData class offers methods to access the UserJob information.

In order to manage the PDF page content, it is advantageous to use a PageContent class. Objects of this class describe for a page which letters are located on the page in which position. It is possible for several letters to be located on one page after the impositioning has been carried out.

Preferably, a DocumentContent hash table is used to manage the page content for each PDF file. In it, the file names and a list of the PageContent are stored for all of the PDF documents. These are preferably generated by a PDFLayer. The information serves for generating an OMR and SDL and for generating a PDF template with static content.

It is also advantageous that a PDF template with the static contents for an existing PDF file with personalization data can be generated at any desired place. In this process, it is checked which template pages are needed. In VariableToTemplateMatch, it is recorded which personalized pages belong to a static page. The information might be needed for a later generation of a book ticket. The VariableToTemplateMatch is entered in VarToTemplateMatchArray for each loop pass.

After the JobEnvironment has been set, the printable files are generated by the PDF kernel on the basis of the virtual printer that is in the configuration. For this purpose, in an especially preferred embodiment of the invention, the kernel has several levels. On the top level (JobHandler), the virtual printer is selected, the PrintJob is read in and the JobEnvironment is initialized. Then the JobHandler incrementally processes the PrepareDocumentStep entries of the virtual printer. On this level, the NewPDF, Loop, Workflow, Personalize, CreateTemplatePDF, PersonalizeOnTemplate, Repeat and OpenPDF entries are recognized and, as a function of the keyword, a method of the next level is called. On the next level (DocumentHandler), the instructions present within the above-mentioned entries are evaluated. The entries that are present in these entries are evaluated by another level (PDFDocument). PDFDocument uses PDFLayer to open and generate the documents.

In an especially preferred embodiment of the invention, an external PDFLib library is incorporated in order to generate and read in the PDF files. This library allows a quick generation of PDF documents by means of function calls. Existing PDF pages can thus also be inserted into new PDF documents. Access to this library preferably takes place via a PDFAccessLayer. In this manner, the remaining code is independent of the library and, in case of a transfer to another library, only the layer has to be adapted.

The layer is also responsible for setting DocumentsContent in the JobEnvironment. Every time a new PDF file is created, an empty PageContent is created and the JobEnvironment is informed of this with the file name. During the personalization, the PDFLayer is informed as to which letter page is being placed. The PDFLayer generates an appropriate PageContent and gives it to JobEnvironment. Every time an existing file is opened, the PDFLayer retrieves the page content (PageContent) from the JobEnvironment. When a page of this device is copied into a new document, the PDFLayer computes the position of the page on the new page and thus generates a PageContent.

In order to convert the PDF files into PostScript, it has proven to be advantageous to use a DLL pdf2ps_java under C. This DLL can address, for example, the Adobe Acrobat and Acrobat Reader programs. The DLL opens the programs and instructs them to convert a PDF file into PostScript. The DLL is loaded by the Pdf2PsNativeInterface class. The Pdf2PsConverter class uses Pdf2PsNativeInterface and makes a conversion method available.

### LIST OF REFERENCE NUMERALS

10 printing system
11 printer
12 sorting machine
13 enveloping machine
14 print processing component
15 print job generation element
16 first message
17 second message
18 call class
20 server
21 web server
22 proxy server
30 database
40 first interface
50 second interface
60 Internet

1. A system for the automatic generation of printable files from data in a database, said system comprising a printing system comprising at least one print processing component having at least one of a printer and a printable file processor, wherein
the printing system comprises at least one print job generation element;
the print job generation element can be connected to a server via a first interface,
the server can be connected to a database via a second interface,
the print job generation element is capable of requesting and receiving data from the database, and
the print job generation element is capable of preparing the data from the database as a function of the requirements of the print processing component and is further capable of generating printable files.

2. The system according to claim 1, wherein the database is located outside of the area of the printing system.

3. The system according to claim 1, wherein the print job generation element is a program on at least one computer of the printing system.

4. The system according to claim 1, wherein the first interface is a SOAP (Simple Object Access Protocol) interface, while the server is a SOAP server.

5. The system according to claim 1, wherein the SOAP interface uses HTTP/HTTPS as a data transmission protocol.

6. The system according to claim 1, wherein the print job generation element can be connected to the server temporarily and/or permanently via the Internet.

7. The system according to claim 1, wherein the second interface is a PL/SQL (Procedural Language/Structured Query Language) layer.

8. A method for the automatic generation of printable files from data in a database, by means of which the files are generated, printed out and/or further processed by a printing system comprising at least one print processing component and one print job generation element comprising the following steps:
the print job generation element generating a first message that contains a call to a server for a specific method with parameters,
the print job generation element establishing a connection to the server via a first interface,
the print job generation element transmitting the first message to the server via the first interface,
the server processing the first message by calling the specific method with appertaining parameters,
the server establishing a connection to the database via a second interface,
the server retrieving data from the database via the second interface,
the server sending the result of the call for the specific method in the form of a second message back to the print job generation element, and
the print job generation element generating at least one printable file from the result of the call for the specific method.

9. The method according to claim 8, comprising communicating between the print job generation element and the server takes place via a SOAP (Simple Object Access Protocol) interface.

10. The method according to claim 9, comprising communicating via an Apache SOAP API (Application Programming Interface).

11. The method according to claim 8 comprising communicating between the server and the database takes place via a PL/SQL (Procedural Language/Structured Query Language) layer.

12. The method according to claim 8, comprising the steps of:
the print job generation element (15) generating a first message by calling an instance of a call class of an Apache SOAP (Simple Object Access Protocol) API (Application Programming Interface) and sets setting properties of this object,
the print job generation element transmits transmitting the first message to the server,
on the part of the server, a web server accepting the first message with the call and evaluating the first message,
associating the sent URL with the Apache SOAP API's RPC router-servlet where the server-SOAP object is known,
transmitting the call to this servlet,
the RPC router-servlet analyzing the first SOAP message, determining the class to be called and initiating the call,
calling the desired method with the transmitted parameters,
converting the return value is converted into a second SOAP message and returning the message as a response via HTTP, and
the instance of the call class on the client side analyzing the second message and returning the obtained result to the print job generation element.

13. The method according to claim 8, comprising the print job generation element checking at the start whether any updates are available on the server and updating its configuration automatically if an update is available.

14. The method according to claim 13, comprising transmitting a new processing file during the updating procedure.
